(19) United States
(12) Patent Application Publication
(10) Pub. No.: US 2008/0272200 A1
(43) Pub. Date: Nov. 6, 2008

(54) Rotary sprayer for a fluid delivery device

(76) Inventors: Timothy R. Ordiway, Racine, WI (US); Michael M. Sawalski, Racine, WI (US); Jeffrey L. Crull, McFarland, WI (US); Steven Merrill Harrington, Cardiff, CA (US); Stephen B. Leonard, Franksville, WI (US)

Correspondence Address: S.C. JOHNSON & SON, INC., 1525 HOWE STREET, RACINE, WI, 53403-2236, US

(21) Appl. No.: 11/800,501

(22) Filed: May 4, 2007

(51) Int. Cl. B05B 3/04; B05D 1/02; E03D 9/02

(52) U.S. Cl. 239/7; 239/223; 4/224

(57) ABSTRACT

A rotary sprayer and method for spraying an inner surface of an enclosure, such as a toilet bowl, with a fluid are disclosed. The rotary sprayer includes a clip and a rotating nozzle. The clip includes a fluid inlet and an arm having a distal end section. The nozzle includes a circular deflection plate, and a pair of spaced apart walls extending away from a surface of the deflection plate. The walls define a channel on the surface of the deflection plate. A passageway is in fluid communication with the channel and an end space between the walls. The fluid inlet is positioned in the end space and a spindle of the nozzle is mounted to the distal end section of the arm. Fluid exiting the fluid inlet flows through the passageway and the channel and contacts an inner surface of at least one of the walls to rotate the nozzle and spray the inner surface wall of the enclosure with the fluid.

### CROSS-REFERENCES TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

This invention relates to a rotary sprayer for a fluid delivery device for spraying a fluid, such as a cleaner or deodorizer, on the inside wall surfaces of an enclosure, such as a toilet bowl, a shower enclosure, or a bathtub enclosure.

2. Description of the Related Art

Toilet bowls require care to prevent the buildup of unsightly deposits, to reduce odors, and to prevent bacteria growth. Traditionally, toilet bowls have been cleaned, deodorized, and disinfected by manual scrubbing with a liquid or powdered cleaning and sanitizing agent. This task has required manual labor to keep the toilet bowl clean.

In order to eliminate the detested manual scrubbing, various toilet bowl cleaner dispensers have been proposed. One type of dispenser comprises a solid block or solid particles of a cleansing and freshening substance that is suspended from the rim of a toilet bowl in a container that is placed in the path of the flushing water. U.S. Pat. No. 4,777,670 (which is incorporated herein by reference along with all other documents cited herein) shows an example of this type of toilet bowl cleaning system. Typically, a portion of the solid block is dissolved in the flush water with each flush, and the flush water having dissolved product is dispensed into the toilet bowl for cleaning the bowl.

Other toilet bowl cleaning systems use a liquid cleaning agent that is dispensed into a toilet bowl. For example, U.S. Pat. Nos. 6,178,564 and 6,230,334, and PCT International Publication Nos. WO 99/66139 and WO 99/66140 all disclose cleansing and/or freshening devices capable of being suspended from the rim of a toilet bowl for introducing liquid active substances from a bottle into the flushing water with each flush. In these under the toilet rim devices, the liquid active substances are delivered downward from a reservoir to a dispensing plate that is supported by a base that is suspended from the toilet bowl rim. The device is suspended from the toilet rim such that the flow of flush water from the toilet contacts the dispensing plate during a flush. The flush water carries the liquid active substances that are on the dispensing plate into the toilet bowl to clean and freshen the toilet.

Other toilet bowl dispensers use an aerosol deodorizing and/or cleaning agent that is dispensed into a toilet bowl through a conduit attached to the toilet bowl rim. For example, U.S. Pat. No. 3,178,070 discloses an aerosol container mounted by a bracket on a toilet rim with a tube extending over the rim; and U.S. Pat. Nos. 6,029,286 and 5,862,532 disclose dispensers for a toilet bowl including a pressurized reservoir of fluid, a conduit connected to the source of fluid, and a spray nozzle which is installed on the toilet rim.

One disadvantage with these known toilet rim dispensing devices is that these devices may only apply the deodorizing and/or cleaning agent to one location in the toilet water or a limited area in the toilet water or on the inner surface of the toilet bowl. As a result, the cleaning of the inner surface of the toilet bowl may be limited to an area of the toilet bowl near the device.

U.S. patent application Ser. No. 11/312,281, owned by the owner of the current invention, sets forth, among others, an automatic or manual toilet bowl cleaning device where the inner surface of the toilet bowl is cleaned around the entire circumference of the toilet bowl. In one embodiment illustrated in that application, the downstream end of a fluid conduit terminates in a rotating nozzle capable of spraying the fluid outwardly onto the inner surface of the toilet bowl.

In view of the advance in the art provided by the device of U.S. patent application Ser. No. 11/312,281, even further improvements to this technology would be beneficial to consumers.

### SUMMARY OF THE INVENTION

The foregoing needs can be met with a rotary sprayer according to the invention for a fluid delivery device. The rotary sprayer is suitable for use in an automated or manual cleaning system for cleaning an enclosure, such as a toilet bowl, a shower enclosure, a bathtub enclosure, and the like. As used herein, the term “cleaning” also includes, without limitation, sanitizing and/or disinfecting, the term “deodorizing” also includes freshening, and the term “fluid” includes, without limitation, cleaning fluids, sanitizing fluids, disinfecting fluids, and the like. Furthermore, the term “fluid” is read broadly to include, liquids, gels, flowable powders, vapors, and the like. Without limitation, an example embodiment of the invention will be described with reference to a toilet bowl. The rotary sprayer is also suitable for use in an automated or manual cleaning system for restoring a surface of an enclosure, such as a toilet bowl, a shower enclosure, a bathtub enclosure, and the like. As used herein, the term ‘restoring’ includes, without limitation, filling in holes, cracks, fissures and the like in a surface. It also includes restoring brightness, shine or any other surface modification to the surface being treated.

In one aspect, the invention provides a rotary sprayer for a fluid delivery device. The rotary sprayer includes a clip and a rotating nozzle supported by the clip. The clip includes a fluid inlet having a discharge orifice and includes an arm having a distal end section axially spaced from the fluid inlet. The nozzle includes a deflection plate, a pair of spaced apart walls extending away from a first surface of the deflection plate and defining a channel on the first surface of the deflection plate, a spindle extending away from an opposite second surface of the deflection plate, and a passageway in fluid communication with the channel and an end space between the pair of walls. The first surface of the deflection plate can include a perimeter section that ramps away from the second surface of the deflection plate. The fluid inlet of the clip is positioned in the end space between the pair of walls of the nozzle, and the spindle of the nozzle is mounted to the distal end section of the arm of the clip. Fluid under pressure is provided to the fluid inlet, and fluid exiting the discharge orifice of the fluid inlet flows through the passageway and through the channel and contacts an inner surface of at least one of the pair of walls to rotate the nozzle and spray fluid around the perimeter of the nozzle.

In the rotary sprayer, the clip can include a hook for mounting the clip on an enclosure. The distal end section of the arm of the clip can include a recess opening toward the fluid inlet, and the spindle of the nozzle can be positioned in the recess.

In one form, the end space between the pair of walls of the nozzle is a depression formed in an end of one or both of the pair of walls. An outer end section of an inner surface of one of the pair of walls can be curved toward the other of the pair of walls. Fluid contacts the curved inner surface section to rotate the nozzle and spray fluid around the perimeter of the nozzle. The pair of walls can be spaced inward from a perimeter of the deflection plate, and the pair of walls can be joined by an end wall such that the channel opens toward one side of the deflection plate. Alternatively, the channel can open toward opposite sides of the deflection plate, and a deflection peak extending away from the first surface of the deflection plate can be positioned between the pair of walls to divide the channel into sections that open toward opposite sides of the deflection plate. In one form, the deflection plate is circular.

In another aspect, the invention provides a rotary sprayer for a fluid delivery device. The rotary sprayer includes a clip and a rotating nozzle supported by the clip. The clip includes a fluid inlet having a discharge orifice and includes an arm having a distal end section axially spaced from the fluid inlet. The nozzle includes a deflection plate having a perimeter, a pair of spaced apart walls extending away from a first surface of the deflection plate, and a deflection peak extending away from the first surface of the deflection plate between the pair of walls. The deflection peak and the pair of walls define oppositely outwardly directed channels on the first surface of the deflection plate. The nozzle also includes a spindle extending away from an opposite second surface of the deflection plate. The nozzle also includes a passageway in fluid communication with the channels and in fluid communication with an end space between the pair of walls which are spaced inward from the perimeter of the deflection plate. Fluid under pressure is provided to the fluid inlet, and fluid exiting the discharge orifice of the fluid inlet flows through the passageway and through the channels and contacts an inner surface of at least one of the pair of walls to rotate the nozzle and spray fluid around the perimeter of the nozzle.

In the rotary sprayer, the clip can include a hook for mounting the clip on an enclosure. The distal end section of the arm of the clip can include a recess opening toward the fluid inlet, and the spindle of the nozzle can be positioned in the recess.

In one version, an outer end section of an inner surface of a first wall of the pair of walls is curved toward a second wall of the pair of walls, and an outer end section of an inner surface of the second wall of the pair of walls is curved toward the first wall of the pair of walls. Fluid contacts the curved inner surface sections to rotate the nozzle and spray fluid around the perimeter of the nozzle. The deflection plate can be circular, and the pair of walls can be generally inverted T-shaped.

In still another aspect, the invention provides a method for spraying an inner wall surface of an enclosure with a fluid. In the method, a rotary sprayer is mounted adjacent a wall of the enclosure. The rotary sprayer includes a clip and a rotating nozzle. The clip can include a fluid inlet having a discharge orifice, and an arm having a distal end section axially spaced from the fluid inlet. The nozzle can include a deflection plate, a pair of spaced apart walls extending away from a first surface of the deflection plate and defining a channel on the first surface of the deflection plate, a spindle extending away from an opposite second surface of the deflection plate, and a passageway in fluid communication with the channel and an end space between the walls. In the rotary sprayer, the fluid inlet is positioned in the end space and the spindle is mounted to the distal end section of the arm. The fluid to be sprayed is moved into the fluid inlet such that fluid exiting the discharge orifice of the fluid inlet flows through the passageway and through the channel and contacts an inner surface of at least one of the pair of walls to rotate the nozzle and spray the inner surface of the enclosure with the fluid.

In the method, the enclosure typically extends upward from a support surface and fluid flowing through the passageway flows downward onto the first surface of the deflection plate in a direction toward the support surface. In one version of the method, the enclosure is a toilet bowl, and the inner surface of the toilet bowl is sprayed around the entire circumference of the toilet bowl. The first surface of the deflection plate can include a perimeter section that ramps away from the second surface of the deflection plate to spray the fluid under the rim of the toilet bowl. In another version of the method, the enclosure is a tub or shower.

In the method, the fluid may be moved into the fluid inlet at a pressure of 20 to 207 kilopascals and/or at a flow rate below 38 liters per hour. In one version of the method, the fluid is pumped into the fluid inlet.

It is therefore an advantage of the invention to provide a rotary sprayer for a fluid delivery device. In one advantageous form, the rotary sprayer can be used in an automatic or manual toilet bowl cleaning device where the inner surface of the toilet bowl is cleaned around the entire circumference of the toilet bowl.

These and other features, aspects, and advantages of the present invention will become better understood upon consideration of the following detailed description, drawings, and appended claims.

### BRIEF DESCRIPTION OF THE DRAWINGS

FIG. 1 is a perspective view of an embodiment of a fluid delivery device according to the invention mounted to a toilet bowl.

FIG. 2 is a perspective, fragmentary view taken along line 2-2 of FIG. 1 showing the clip and rotating nozzle of a rotary sprayer according to the invention.

FIG. 3 is a side elevational view having a cutout showing a portion of the interior of the clip and the rotary sprayer of FIG. 2.

FIG. 4 is a rear oblique view of the clip of FIG. 2.

FIG. 5 is a front view of a portion of the clip of FIG. 2 showing a hook of the clip.

FIG. 6 is a rear view of a portion of the clip of FIG. 2 showing a base of the clip.

FIG. 7 is a front view of the clip and rotating nozzle of the rotary sprayer of FIG. 2 showing the clip in rotated (dashed lines) and non-rotated (solid lines) orientations.

FIG. 8 is a top view of the nozzle of the rotary sprayer taken along line 8-8 of FIG. 3.

FIG. 9 is a perspective view of another embodiment of a clip and rotating nozzle of a rotary sprayer according to the invention.

FIG. 10 is a side view of the clip and rotating nozzle of the rotary sprayer of FIG. 9.

FIG. 11 is a front view of the clip and rotating nozzle of the rotary sprayer of FIG. 9 with the hook removed.

FIG. 12 is a vertical cross-sectional view of the fluid inlet, nozzle and support arm of the rotary sprayer of FIG. 9.

FIG. 13 is a top view of the nozzle of the rotary sprayer taken along line 13-13 of FIG. 10.

FIG. 14 is a front elevational view of yet another nozzle suitable for use with the rotary sprayer of the invention.

FIG. 15 is a side elevational view of the nozzle of FIG. 14.

FIG. 16 is a perspective view of a fluid dispensing pump that may be used to pump fluid from a container to the rotary sprayer of the invention.

FIG. 17 is a vertical cross-sectional view of the fluid dispensing pump of FIG. 16.

FIG. 18 is a front view of another fluid dispensing pump that may be used to pump fluid from a container to the rotary sprayer of the invention.

FIG. 19 is a detailed vertical cross-sectional view of the fluid delivery system of the fluid dispensing pump of FIG. 18 taken along line 19-19 of FIG. 18.

Like reference numerals will be used to refer to like parts from Figure to Figure in the following description of the drawings.

### DETAILED DESCRIPTION OF THE INVENTION

A rotary sprayer according to the invention can be used in various devices that dispense fluid onto the inside surfaces of an enclosure, such as a toilet bowl, a shower enclosure, a bathtub enclosure, or the like. Various embodiments of the invention will now be described with reference to the Figures. The embodiments are shown and described for the purposes of illustration and are not intended to limit the invention in any way.

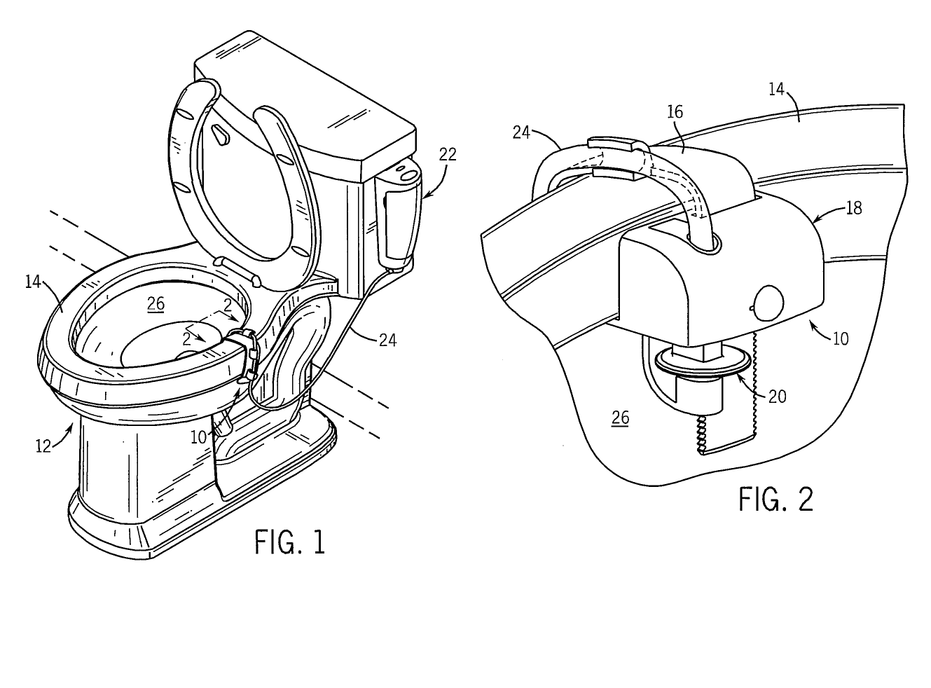

Turning to FIGS. 1 and 2, there is shown an example embodiment of a rotary sprayer with a clip 10 for mounting the rotary sprayer to an enclosure, here a toilet bowl 12 on a support surface 13. The clip 10 is secured to the rim 14 of the toilet bowl 12 by a hook 16. A base 18 is supported by the hook 16 and rotatably supports a nozzle 20. A container 22 supplies fluid via a fluid conduit 24 to the nozzle 20 to be dispensed onto the inside surface 26 of the toilet bowl 12. The fluid can be supplied from the container 22 to the nozzle 20 in a variety of ways; for example, the fluid may be moved by a gaseous propellant, by a pump, a syringe, or any other suitable means. Furthermore, the execution of the fluid delivery from the container 22 can be controlled by a variety of methods/devices, one being a timing circuit using predetermined logic to control when the fluid is dispensed.

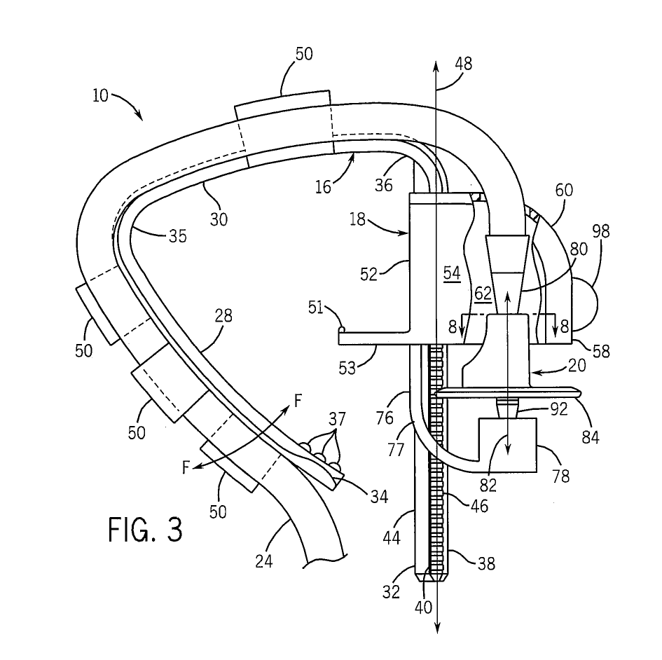

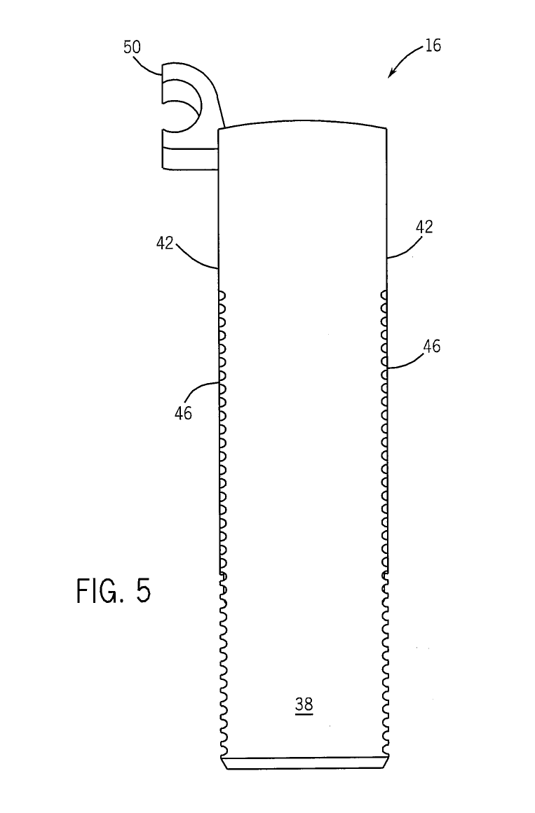

Turning to FIGS. 3, 4, and 5 the hook 16 for supporting the base 18 and attaching the clip 10 to the toilet bowl 12 has three main segments. A bowl segment 28, a top rim segment 30, and an inner rim segment 32. All three segments 28, 30, 32 are preferably integrally molded from plastic (e.g., polyethylene or polypropylene) and form a flexible hook 16. The bowl segment 28 has a substantially rectangular cross-section and a flared elastomeric gripping foot 34 with elastomeric ribs 37 at a lower end for helping to secure the clip 10 to the toilet bowl 12. Suitable elastomeric materials for the gripping foot 34 and ribs 37 include, without limitation, neoprene, polyurethane rubbers, and silicone rubbers. The bowl segment 28 extends substantially vertically upward and transitions into the top rim segment 30 at a flexible elbow 35 that allows the hook 16 to flex predominantly in the F-F direction (shown on FIG. 3) to secure the clip 10 to toilet bowls of various shapes and sizes. The top rim segment 30 has a substantially rectangular cross-section and extends horizontally across the rim 14 of the toilet bowl 12 where it transitions into the inner rim segment 32 at another flexible elbow 36, also allowing the hook 16 to flex. The inner rim segment 32 extends vertically downward from the elbow 36 and is configured to engage and support the base 18.

The inner rim segment 32 of the hook 16 has a front face 38 and a rear face 40 joined by two short side faces 42. A rib 44 protrudes from the rear face 40 of the inner rim segment 32 and extends the length thereof. As discussed in detail below, the rib 44 limits the angle of rotation of the base 18 with respect to the hook 16. The rib 44 of the example embodiment has a substantially rectangular cross-section, however, the rib 44 may have a curved cross-section, a square cross-section, comprise two spaced apart members, and the like. Additionally, the rib 44 need not extend the length of the inner rim segment 32 provided the rib 44 engages the base 18 throughout the desired adjustable range of the base 18. The short side faces 42 have ratchet teeth 46 used in conjunction with the base 18 to restrain vertical movement of the base 18 along a vertical axis 48. Other restraints may be used, such as a friction fit between the hook 16 and base 18, or the like.

The bowl segment 28 and the top rim segment 30 include a series of C-shaped channels 50 that restrain the conduit 24 as it is routed around the perimeter of the hook 16 on its way to the nozzle 20 in the base 18. The bowl segment 28 of the present embodiment includes three C-shaped channels 50 of alternating openings. The conduit 24 is pressed into the C-shaped channels 50, however, the channels 50 could be rectangular or any other suitable shape to restrain the conduit 24. The top rim segment 30 preferably includes one channel 50 helping to route the conduit 24, however, more may be used if needed.

Turning to FIGS. 3, 4, and 6 the base 18 has a back face 52, a pair of spaced apart side faces 54 extending forward of the back face 52, a top face 56 and a front face 58 extending between the side faces 54, and a curved face 60 extending between the side faces 54, top face 56, and front face 58. The faces 52, 54, 56, 58, 60 define a partial cavity 62 housing a portion of the nozzle 20. The base 18 has a tab 53 that extends rearward from the back face 52 of the base 18. The tab 53 helps orientate the base 18 with respect to the rim 14 when the clip 10 is mounted to the toilet bowl 12, as discussed below. The tab 53 may be one continuous member as shown in the example embodiment, or alternatively, the tab 53 may include a plurality of members extending from the base 18. The base 18 is preferably molded from plastic (e.g., polyethylene or polypropylene).

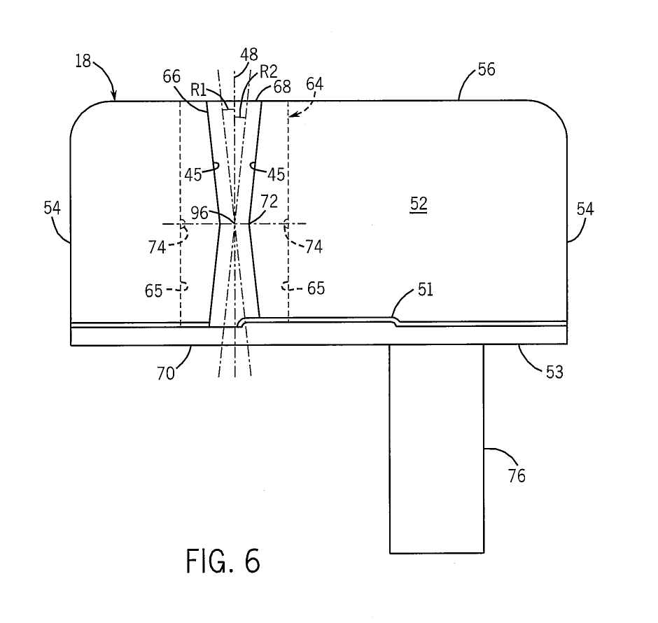

With emphasis on FIG. 6, the base 18 includes a channel 64 for receiving the inner rim segment 32 of the hook 16. The channel 64 includes a slit 66 for receiving the rib 44 having an entrance 68, an exit 70, and an intermediate position 72 (which may or may not be equidistant from the entrance 68 and the exit 70). The width of the slit 66 decreases from the entrance 68 to the intermediate position 72 and increases from the intermediate position 72 to the exit 70. In one embodiment, the intermediate position 72 is approximately half way between the entrance 68 and the exit 70; however, the narrowest point need not be halfway between the entrance 68 and exit 70, but may occur anywhere between the extremes of the slit 66. Additionally, the maximum width of the slit 66 may vary depending on the desired degree of adjustment of the base 18 with respect to the hook 16. If greater rotational adjustment of the base 18 is desired, the maximum width of the slit 66 at the entrance 68 and exit 70 may be increased; alternatively, or in addition, the width of the rib 44 may be decreased.

The channel 64 includes a pair of projections 74 extending from the walls of the short sides 65 of the channel 64 to engage the ratchet teeth 46 of the hook 16 as the inner rim segment 32 slides within the channel 64. The projections 74 are configured to engage the ratchet teeth 46 to inhibit vertical sliding of the base 18 with respect to the hook 16. The projections 74 may be rounded, terminate in a point, or other suitable geometry. Many other structures are capable of providing the desired restraint, such as a spring-loaded ball that is housed in a cavity formed in the channel 64 to urge the ball against a contour (e.g., ratchet teeth 46) of the channel 64. The engagement between the projections 74 and the ratchet teeth 46 is such that the base 18 is capable of the desired rotation (discussed below) without causing the projections 74 and ratchet teeth 46 to disengage.

The base 18 further includes a means to attach the nozzle 20. In the example embodiment, the nozzle 20 is restrained laterally between a fluid inlet 80 and a barrel 78. The base 18 includes an arm 76 extending downward from the base 18. The arm 76 has a flat bar support segment 77 with a J-shaped bend extending forward with a barrel 78 located at the distal end of the support segment 77. The barrel 78 includes a tubular recess for receiving the bottom of the nozzle 20. The base 18 also has a fluid inlet 80 located in the curved face 60 that tapers from the opening (shown in FIG. 3). The fluid inlet 80 and the barrel 78 are used in conjunction to restrain lateral movement of the nozzle 20, but allow the nozzle 20 to rotate about the nozzle axis 82.

A sensor 98 for sensing the environment surrounding the clip 10 may be mounted to the base 18 or hook 16. Preferably, the sensor 98 is mounted substantially to the front face 58, but may be mounted on the angled face 60 or any other suitable location providing a view, for example, of the user to accurately determine the presence or absence thereof. The sensor 98 may be a motion sensor, proximity sensor, or the like. The sensor 98 is preferably electrically connected to the container 22 and/or controller (not shown) to influence when the fluid is dispensed to the toilet bowl 12 based upon predetermined logic.

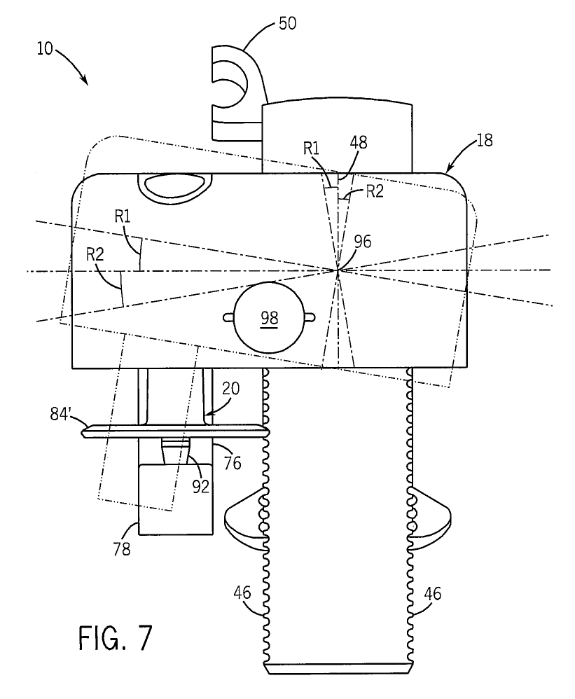

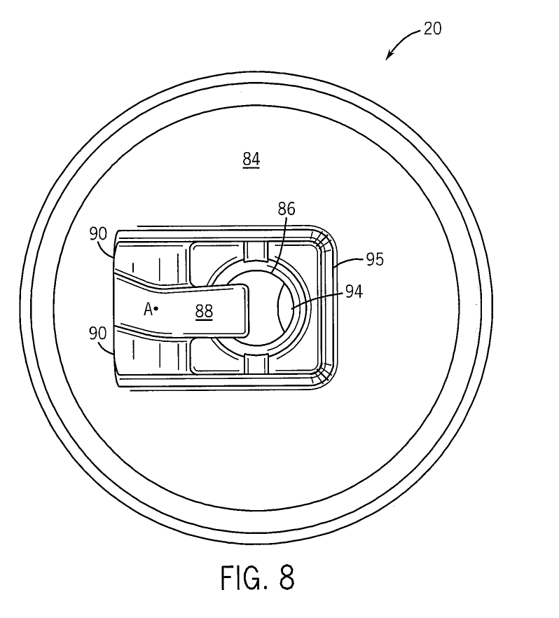

Turning to FIG. 8, an example embodiment of the nozzle 20 is described. The nozzle 20 is preferably molded from plastic (e.g., polyethylene and polypropylene). The nozzle 20 includes a circular deflection plate 84, a passageway 86 extending upwards from the deflection plate 84 and in fluid communication with the fluid inlet 80. A channel 88 extends radially outward from the passageway 86 near the deflection plate 84 and angles away from the initial channel 88 path at point A as shown in FIG. 8. The channel 88 is flanked by a pair of fins 90 that extend upwardly from the deflection plate 84. The fins 90 extend away from an end wall 95. An outer edge of the deflection plate 84 has a chamfer 84′ (see FIG. 7) that ramps downward from the top of the deflection plate 84. The contour of the chamfer 84′, channel 88 and fins 90 may vary depending on the desired rotational speed of the nozzle 20, pressure of the fluid, and the like.

As shown most clearly in FIGS. 3 and 8, the nozzle 20 is restrained laterally in the base 18 by inserting a spindle 92 extending from the underside of the deflection plate 84 into the recess in the barrel 78 of the arm 76 and by inserting the tapered end of the fluid inlet 80 into the passageway 86 where it abuts a ledge 94 formed in the passageway 86. The nozzle 20 is free to rotate about the nozzle axis 82, but is restrained from lateral movement.

The nozzle 20 may be suspended from the base 18 without the use of an arm 76. The nozzle 20, may be snap-fit to the base 18, screwed to the base 18, wedged to the base 18, and the like. Furthermore, an arcuate arm (not shown) may extend from the base 18 to support the nozzle 20.

In operation, fluid is moved from the container 22 through the conduit 24, which is routed through the channels 50 along the hook 16, and into the fluid inlet 80 on the base 18. Fluid flows into the top of the nozzle 20, down the passageway 86 where it is directed radially outward by the channel 88. As the fluid exits the channel 88 its path is altered by the angled fins 90 flanking the channel 88. The reaction causes the nozzle 20 to rotate counterclockwise as viewed in FIG. 8. As a result, the fluid is expelled radially outward from the nozzle 20 onto the inside surface 26 of the toilet bowl 12.

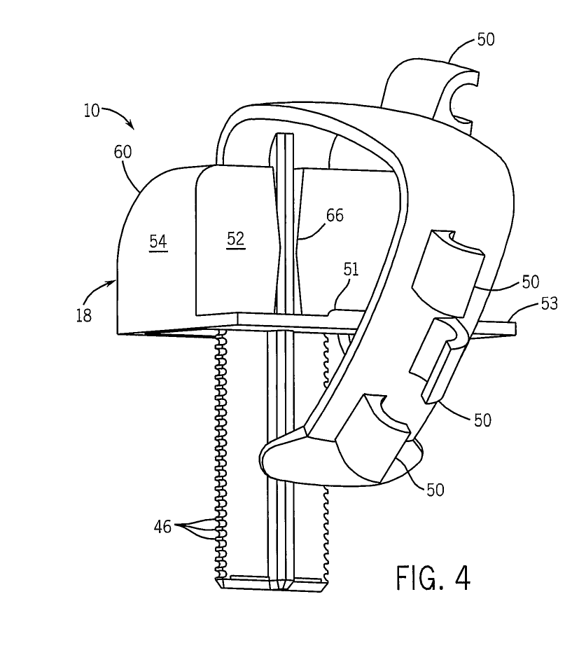

With the general structure and operation of the fluid delivery device described, we turn our attention to the means for rotating the base 18 and thus adjusting the area covered by the fluid dispensed from the nozzle 20. Returning to FIGS. 4 and 6, and with reference to FIG. 7, the base 18 can be rotated relative to the hook 16 about a horizontal axis 96 extending substantially normal from a plane defined by the vertical axis 48 and the back face 52 of the base 18. The slit 66 formed in the channel 64 is flared at the entrance 68 and exit 70. This allows the base 18 to rotate near the intermediate position 72 about the horizontal axis 96 until the rib 44 protruding from the hook 16 abuts the slit sides 45 formed in the back face 52.

For example, with reference to FIG. 7, when the base 18 is rotated by an angle R1 with respect to the vertical axis 48 (shown by dashed lines) the relative placement of the nozzle 20 is angled accordingly, thus altering the area covered by the fluid dispensed from the nozzle 20. Additionally, when the base 18 is rotated by an angle R2 in the opposite direction, the coverage of the fluid dispensed by the nozzle 20 is again altered. As the base 18 rotates, the projections 74 slide within a respective tooth of the ratchet teeth 46; thus, the fit between the projections 74 and the ratchet teeth 46 should allow for the base 18 to rotate freely while also inhibiting vertical movement of the base 18. This rotational adjustment allows the clip 10 to accommodate toilets and enclosures of varying geometries.

The means for rotating the base 18 need not include a slit 66 as described. For example, the back face 52 may include several pairs of opposed fingers in the plane defined by the back face 52 for restraining the rotation of the rib 44 of the hook 16. The opening between a pair of opposed fingers near the entrance and the opening of a pair of opposed fingers near the exit are larger than the opening between a pair of opposed fingers located between the entrance and exit fingers. As a result, the base 18 is capable of rotating until the rib 44 engages the fingers near the entrance and exit. In another embodiment, the slit 66 may have a V-shape wherein the entrance tapers to the exit, or the opposite. Thus, the point of rotation of the base 18 is located near the exit of the slit 66, or smaller of the entrance and exit. Again, the rotation of the base 18 is limited by the rib 44 engaging the slit sides 45.

The rotational adjustment of the base 18 may be performed manually by a user of the clip 10 or automatically as the clip 10 is mounted to the enclosure, here a toilet bowl 12. With general reference to FIGS. 1-4, 6, and 7, the clip 10 is mounted substantially as follows. The clip 10 is secured to the rim 14 of the toilet bowl 12 by urging the hook 16 in the F-F direction away from the base 18 and placing the clip 10 over the rim 14. Once the hook 16 is secured, the base 18 is slid along the vertical axis 48 up the hook 16 and ratchet teeth 46 until the tab 53 engages the underside of the rim 14. As the tab 53 of the base 18 continues to engage the underside of the rim 14, the base 18 is rotated about the horizontal axis 96, thus aligning the nozzle 20 with the plane of the underside of the rim 14 and helping to ensure that the fluid from the nozzle 20 is dispensed onto the inside surface 26 of the toilet bowl 12 (assuming the plane of the underside of the rim 14 is parallel with the plane defined by the topside of the rim 14). The tab 53 may further include an elastomeric grip 51 protruding from the distal end of the tab 53 helping to secure the base 18 in its engaged position on the rim 14. The base 18 need not include a tab 53; in this embodiment, the base 18 may be manually rotated by the user to adjust the base 18 with respect to the hook 16.

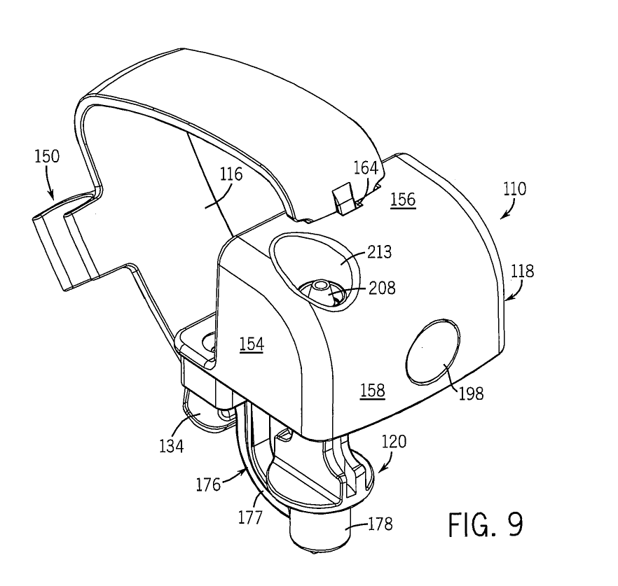

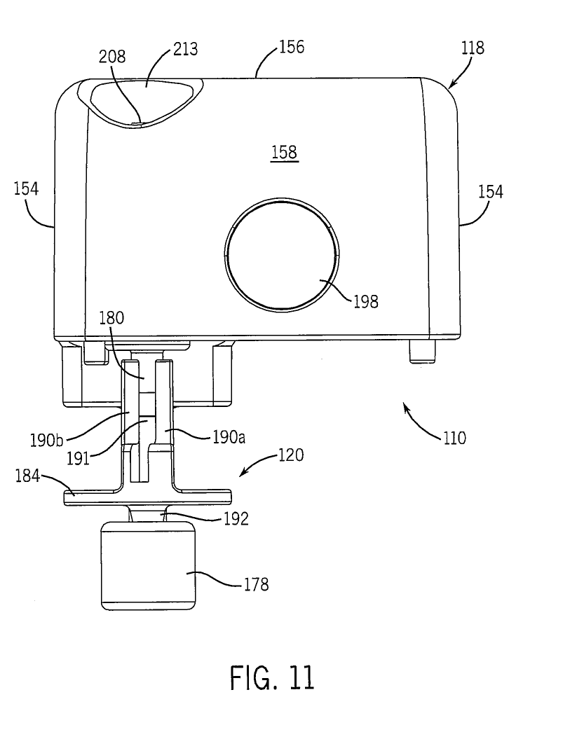

Turning now to FIGS. 9-11, there is shown another example embodiment of a rotary sprayer with a clip 110 for mounting a nozzle to an enclosure such as a toilet bowl. The clip 110 is secured to the rim of the toilet bowl by a hook 116 (which is omitted in the view of FIG. 11) in the same manner as the clip 10 of FIGS. 1-8. A base 118 is supported by the hook 116 and supports a nozzle 120. A container supplies fluid via a fluid conduit to the nozzle 120 to be dispensed onto the inside surface of the toilet bowl in the same manner as the clip 10 of FIGS. 1-8. The fluid can be supplied from the container to the nozzle 120 in a variety of ways; for example, the fluid may be moved by a gaseous propellant, by a manual or electric pump, a syringe, or any other suitable means. Furthermore, the execution of the fluid delivery from the container can be controlled by a variety of methods/devices, one being a timing circuit using predetermined logic to control when the fluid is dispensed.

Referring still to FIGS. 9-11, the hook 116 for supporting the base 118 and attaching the clip 110 to the toilet bowl has three main segments. A bowl segment 128, a top rim segment 130, and an inner rim segment 132. All three segments 128,130,132 are preferably integrally molded from plastic (e.g., polyethylene or polypropylene) and form a flexible hook 116. The bowl segment 128 has a substantially rectangular cross-section and a flared elastomeric gripping foot 134 with elastomeric ribs 137 at a lower end for helping to secure the clip 110 to the toilet bowl in the same manner as the clip 10 of FIGS. 1-8. Suitable elastomeric materials for the gripping foot 134 and ribs 137 include, without limitation, neoprene, polyurethane rubbers, and silicone rubbers. The bowl segment 128 extends substantially vertically upward and transitions into the top rim segment 130 at a flexible elbow 135 that allows the hook 116 to flex (as in the F-F direction shown on FIG. 3) to secure the clip 110 to toilet bowls of various shapes and sizes. The top rim segment 130 has a substantially rectangular cross-section and extends horizontally across the rim of the toilet bowl where it transitions into the inner rim segment 132 at another flexible elbow 136, also allowing the hook 116 to flex. The inner rim segment 132 extends vertically downward from the elbow 136 and is configured to engage and support the base 118. The bowl segment 128 and the top rim segment 130 include a C-shaped channel 150 that restrains the fluid conduit as it is routed around the perimeter of the hook 116 on its way to the nozzle 120 in the base 118. The fluid conduit is pressed into the C-shaped channel 150 in the same manner as the clip 10 of FIGS. 1-8. The base 118 has a back face 152, a pair of spaced apart side faces 154 extending forward of the back face 152, a top face 156 and a front face 158 extending between the side faces 154. The faces 152,154,156,158 define a cavity. The base 118 is preferably molded from plastic (e.g., polyethylene or polypropylene).

The base 118 includes a channel 164 for receiving the inner rim segment 132 of the hook 116. The channel 164 is structured similar to the channel 64 of the clip 10 of FIGS. 1-8, and the channel 164 and the hook 116 provide rotational adjustment of the base 118 using the same construction in the same manner as the clip 10 of FIGS. 1-8 so the means for rotational adjustment of the clip 110 will not be explained further.

A sensor 198 for sensing the environment surrounding the clip 110 may be mounted to the base 118. Preferably, the sensor 198 is mounted substantially to the front face 158, but may be mounted on any other suitable location providing a view, for example, of the user to accurately determine the presence or absence thereof. The sensor 198 may be a motion sensor, proximity sensor, or the like. The sensor 198 is preferably electrically connected to the container and/or controller (not shown) to influence when the fluid is dispensed to the toilet bowl based upon predetermined logic.

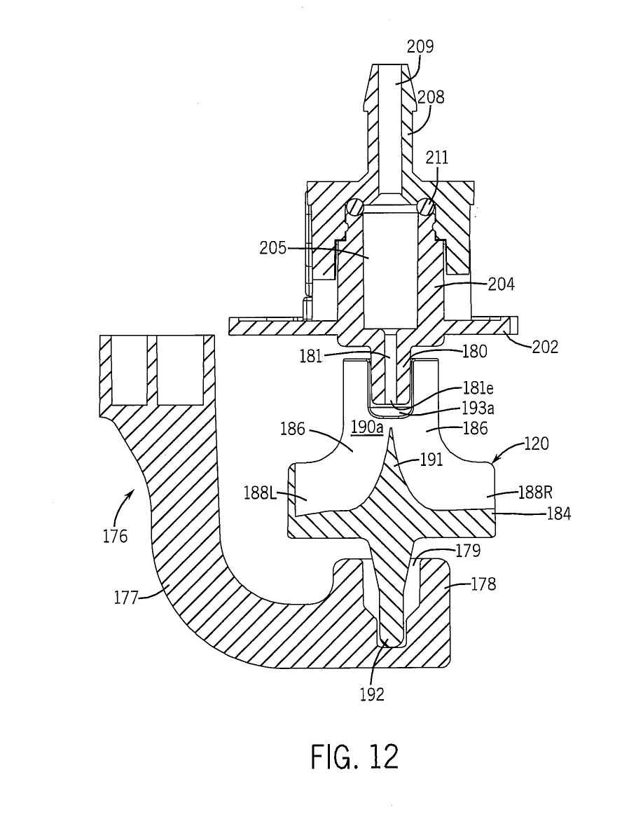

Looking at FIG. 12, the base 118 further includes a means to attach nozzle 120 to the base 118. In the example embodiment, the nozzle 120 is restrained laterally between a barrel 178 and a fluid inlet 180. The base 118 includes an arm 176 extending downward from the base 118. The arm 176 has a curved section 177 with a J-shaped bend extending forward to the barrel 178 located at the distal end of the curved section 177. The fluid inlet 180 and the barrel 178 are used in conjunction to restrain lateral movement of the nozzle 120, but allow the nozzle 120 to rotate about the nozzle axis 182. The tubular fluid inlet 180 defines a flow path 181 that terminates in a discharge orifice 181e, and extends downwardly from a lower base floor 202 that is attached to the base 118. The base floor 202 includes an upwardly extending tubular sleeve 204 that defines a flow path 205. The base 118 is also attached to a fluid supply port 208 that defines a flow path 209. The fluid supply port 208 and the tubular sleeve 204 are snap fit together with an O-ring 211 therebetween to create fluid tight seal. The fluid supply port 208 is located in a recess 213 in the top face 156 of the base, and may be connected to a fluid conduit (such as conduit 24 in FIG. 3).

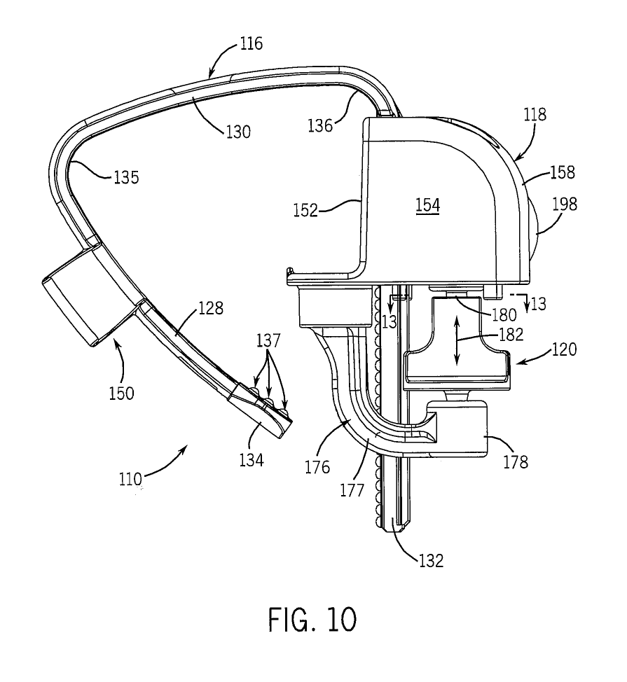

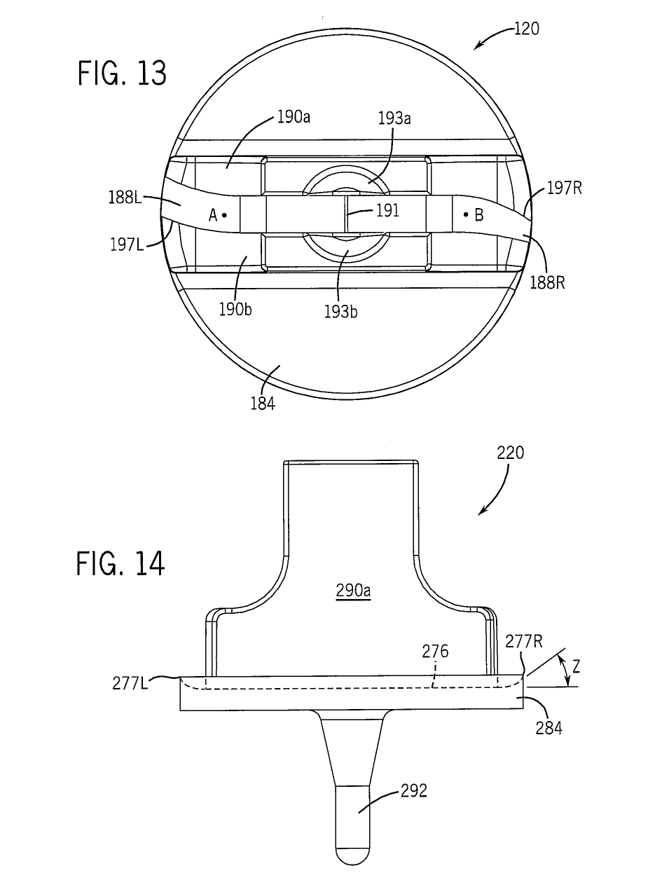

Referring to FIGS. 10 and 12 and 13, the nozzle 120 is shown in greater detail. The nozzle 120 is preferably molded from plastic (e.g., polyethylene and polypropylene). The nozzle 120 includes a circular deflection plate 184. An axial spindle 192 extends downward from a bottom surface of the deflection plate 184. Spaced apart walls 190a, 190b, which have a generally inverted T-shape, extend upward from the deflection plate 184. In the embodiment of FIG. 13, the walls 190a, 190b, extend all the way across the deflection plate 184 from opposed outer edges of the deflection plate 184. A central fluid deflection peak 191 extends upward from the deflection plate 184 between the walls 190a, 190b. The top of the wall 190a has a generally U-shaped (when viewed in vertical cross-section) inwardly directed depression 193a, and the top of the wall 190b has a generally U-shaped (when viewed in vertical cross-section) inwardly directed depression 193b. A passageway 186 is defined by the walls 190a, 190b and the passageway 186 extends upwards from the deflection plate 184 and in is fluid communication with the depressions 193a, 193b. A channel 188L extends radially outward from the passageway 186 near the deflection plate 184 and angles rearwardly away from the initial channel 188L path at point A as shown in FIG. 13. A channel 188R extends radially outward from the passageway 186 near the deflection plate 184 and angles forwardly away from the initial channel 188R path at point B as shown in FIG. 13. The contour of the channels 188L, 188R and walls 190a, 190b may vary depending on the desired rotational speed of the nozzle 120, the pressure of the fluid, the flow rate of the fluid, and the like.

As shown most clearly in FIG. 12, the nozzle 120 is restrained laterally by inserting a spindle 192 into a recess 179 in the barrel 178 of the arm 176 and by inserting the end of the fluid inlet 180 between depressions 193a, 193b. The nozzle 120 is free to rotate about the nozzle axis 182, but is restrained from lateral movement.

In operation, fluid is moved from a container through a fluid conduit (see, for example, the container 22 and the conduit 24 of FIG. 1) and into the fluid supply port 208. Looking at FIG. 12, the fluid flows through the flow paths 209, 205, and 181, and out of the fluid inlet 180. (The diameter of the exit orifice of the fluid inlet can dictate the pressure which helps to dictate the spin rate and the distance of fluid travel off the nozzle 120.) Fluid flows onto the top of the fluid deflection peak 191 and down the forked passageways 186 where it is directed radially outward by the channels 188L, 188R. As the fluid exits the channels 188L, 188R, the fluid path is altered by the angled inner surfaces 197L, 197R flanking the channels 188L, 188R. The reaction causes the nozzle 120 to rotate counterclockwise as viewed in FIG. 13. As a result, the fluid is expelled radially outward from the nozzle 120 onto the inside surface of the enclosure such as a toilet bowl.

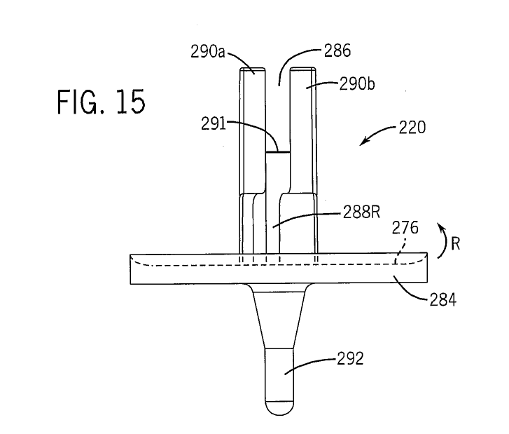

Referring to FIGS. 14 and 15, another embodiment of a nozzle 220 is shown in greater detail. The nozzle 220 is preferably molded from plastic (e.g., polyethylene and polypropylene). The nozzle 220 includes a circular (from a top view) deflection plate 284. An axial spindle 292 extends downward from the bottom surface of the deflection plate 284. Spaced apart walls 290a, 290b, which have a generally inverted T-shape, extend upward from the deflection plate 284. In the embodiment of FIGS. 14 and 15, the walls 290a, 290b, extend from a location spaced inward from an outer edge point 277L of the deflection plate 284 to a location spaced inward from an outer edge point 277R of the deflection plate 284. A central fluid deflection peak 291 (similar to fluid deflection peak 191 of FIGS. 12 and 13) extends upward from the deflection plate 284 between the walls 290a, 290b. The top of the wall 290a has a generally U-shaped inwardly directed depression (similar to inwardly directed depression 193a in FIGS. 12 and 13), and the top of the wall 290b has a generally U-shaped inwardly directed depression (similar to inwardly directed depression 193b in FIGS. 12 and 13).

Still referring to FIGS. 14 and 15, a passageway 286 (similar to passageway 186 in FIGS. 12 and 13) is defined by the walls 290a, 290b and the passageway 286 extends upwards from the deflection plate 284 and in is fluid communication with the depressions in the walls 290a, 290b. A channel (similar to channel 188L in FIGS. 12 and 13) extends radially outward from the passageway 286 near the deflection plate 284 and angles rearwardly away from the initial channel as in FIG. 13. A channel 288R extends radially outward from the passageway 286 (similar to channel 188R in FIGS. 12 and 13) and angles forwardly away from the initial channel 288R path as shown in FIG. 15. The deflection plate 284 has a dished upwardly facing floor 276 that creates a draft angle Z (see FIG. 14) at the outer edge of the top of the deflection plate 284. The contour of the draft angle Z, the channels, and the walls 290a, 290b may vary depending on the desired rotational speed of the nozzle 220, the pressure of the fluid, the flow rate of the fluid, and the like.

Similar to FIG. 12, the nozzle 220 may be restrained laterally by inserting the spindle 292 into a recess 179 in the barrel 178 of the arm 176 and by inserting the end of the fluid inlet 180 between upper depressions in the walls 290a, 290b. The nozzle 220 is free to rotate about the nozzle axis, but is restrained from lateral movement.

In operation, fluid is moved from a container through a fluid conduit (see, for example, the container 22 and the conduit 24 of FIG. 1) and into the fluid supply port 208 as in FIG. 12, the fluid flows through the flow paths 209, 205, and 181, and out of the fluid inlet 180. Fluid flows onto the top of the fluid deflection peak 291 of nozzle 220 and down the forked passageways 286 where it is directed onto the floor 276 and radially outward by the channels. As the fluid exits the channels, the fluid path is altered by the angled inner surfaces of the walls 290a, 290b flanking the channels. The reaction causes the nozzle 220 to rotate right in direction R as in FIG. 15. The fluid continues to flow on the floor 276 and then moves up the draft angle at the edge of the deflection plate 284 to create a slightly upward travel path for the fluid. As a result, the fluid is expelled radially outward from the nozzle 220 onto the inside surface of the toilet bowl, with the slightly upward travel path for the fluid allowing for under the toilet rim contact of the fluid with the inner surface of the toilet bowl even after 18 or more inches of travel.

Comparing FIGS. 8,13 and 14, the nozzle 20, the nozzle 120, and the nozzle 220 have differences in structure that can lead to different operating characteristics. For example, the nozzle 20 has a single channel 88 extending away from the passageway 86, whereas nozzle 120 and nozzle 220 have two channels extending away from the central passageway. The extra passageway can serve to get maximum work out of the nozzle and improve efficiency. The nozzle 120 and nozzle 220 also have fluid deflection peaks 191, 291 that can improve efficiency. Comparing nozzle 120 and nozzle 220, it can be seen that the walls 190a, 190b of nozzle 120 extend all the way across the deflection plate 184 from opposed outer edges of the deflection plate 184, whereas walls 290a, 290b of nozzle 220 are spaced inward from opposed outer edges of the deflection plate 284. The spacing of the walls from the edge of the plate can create more tangential motion in the fluid expelled from the nozzle 220. The centripetal force causes fluid to spin and shear off. Also, the draft angle Z at the outer edge of the nozzle 220 can provide for a spray of about 18 inches (measured radially from the outer edge of the deflection plate) without having the level of liquid spray drop down. This is advantageous as it prevents the spray from failing down so far that it does not hit under the upper areas under the toilet rim.

Various parameters of the nozzles 20, 120, 220 can be varied depending on the application for the nozzles. For example, in a nozzle suitable for use in a toilet cleaning device, fluid flow is downward unto the deflection plate to create a spray that moves downward less quickly after leaving the surface of the deflection plate. The design parameters of the nozzles 20, 120, 220 can be varied to accommodate lower fluid pressures, such as 10 to 20 psi (69 to 138 kilopascals), and fluid travel paths of less than 24 inches (0.6096 meters) (measured radially from the outer edge of the deflection plate), and flow rates below 10 gallons per hour (about 38 liters per hour). Therefore, the operating parameters of pressure, volume, and flow rate can be accommodated by varying the design of the nozzles 20, 120, 220. Fluid pressures of 3 to 30 psi (20 to 207 kilopascals) and fluid travel paths of up to 100 inches (2.54 meters) (measured radially from the outer edge of the deflection plate) are suitable for many applications. Fluid pressures of 14 to 15 psi (96 to 103 kilopascals) and fluid travel paths of up to 18 inches (0.4572 meters) (measured radially from the outer edge of the deflection plate) are most preferred in a toilet application.

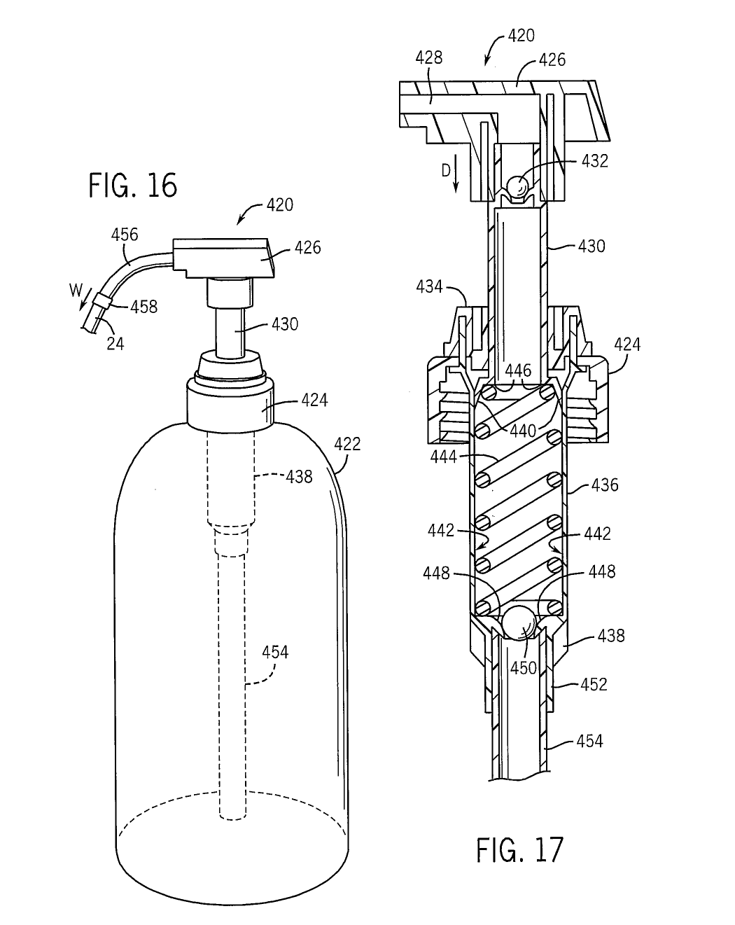

Having described the clips 10, 110 and the nozzles 20, 120, 220 of a rotary sprayer, various pumps for supplying fluid from the container to the nozzles 20, 120, 220 can be described. Referring to FIGS. 16 and 17, there is shown a fluid dispensing pump 420 that may be used to pump fluid from a container 422 to the conduit 24 that supplies fluid to the nozzles 20, 120, 220 as described above. The fluid dispensing pump 420 can be mounted on the side of the toilet tank as in FIG. 1, or placed on the top of the toilet tank, or placed on the floor. The fluid dispensing pump 420 may be attached to the container 422 by way of a threaded closure 424 in a conventional manner.

The fluid dispensing pump 420 includes a dispenser head 426 that defines an actuator and has a discharge conduit 428. The dispenser head 426 is attached to a hollow tubular piston 430 having a ball valve 432 at its upper end. The piston 430 translates in a collar 434 that is secured in an aperture in the closure 424. The fluid dispensing pump 420 also includes an accumulator 436 that defines a pump chamber and is contained in a housing 438. An annular seal 440 at the bottom of the piston 430 seals against an inner surface 442 of the accumulator 436. A helical compression spring 144 is arranged between lower shoulders 446 of the piston 430 and lower shoulders 448 of the accumulator 436. The accumulator 436 includes a ball valve 450 at its lower end. The accumulator 436 also has a tubular inlet port 452 that receives a dip tube 454 for sucking fluid from the container 422. The accumulator 436 is oriented collinear with a vertical (longitudinal) axis of the container 422.

The dispenser head 426 is shown in FIG. 17 in its upper position. When the dispenser head 426 is pressed downward in direction D from its upper position by a hand (or a foot) and released, fluid from the container is suctioned into the accumulator 436 on the upstroke of the piston 430 (the upstroke being effectuated by the upward biasing force of the spring 444). After a number of downstrokes and upstrokes of the piston 430, sufficient fluid is present in the accumulator 436 such that subsequent downstrokes of the piston 430 force fluid upward past the ball valve 432 and out the discharge conduit 428. The discharge conduit 428 is in fluid communication with a conduit 456 that is in fluid communication with conduit 24 by way of a one way check valve assembly 458 that only allows fluid flow in direction W shown in FIG. 16. Fluid entering the conduit 24 is sprayed by nozzle 20 or 120 or 220 onto the inside surface 26 of the toilet bowl 12 as described above. The amount of fluid delivered by a downstroke of the fluid dispensing pump 420 can vary depending on the size of the pump components such as the piston 430 and the accumulator 436. In one example embodiment, the fluid dispensing pump 420 delivers 8 milliliters of fluid on a downstroke of the piston 430. Fluid pressures can be in the range of 10 to 20 psi (69 to 138 kilopascals).

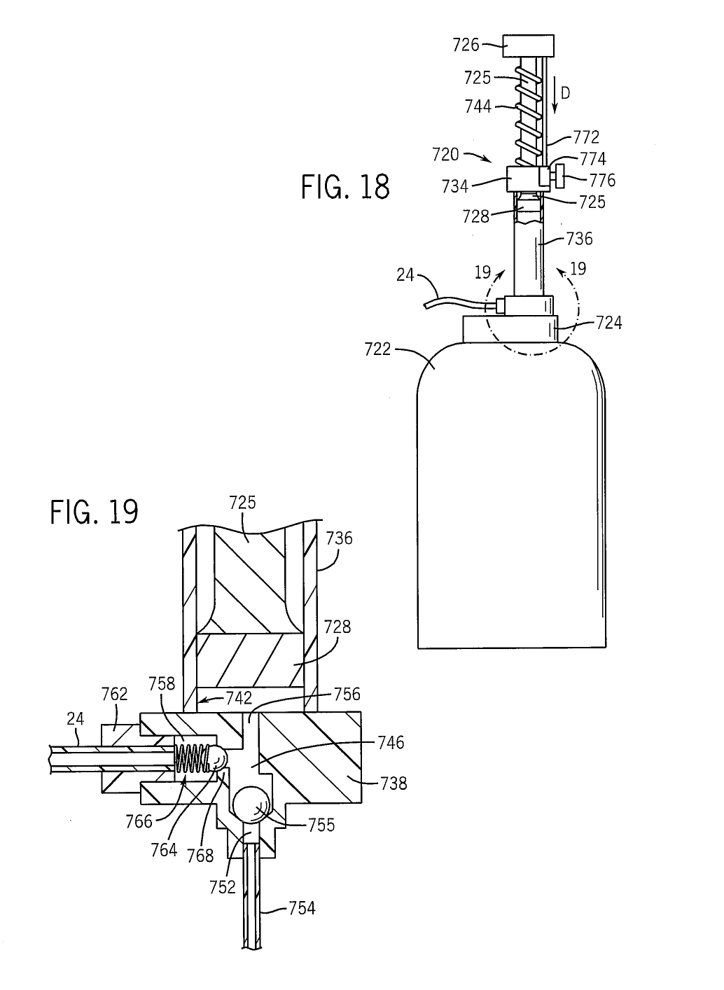

Referring to FIGS. 18 and 19, there is shown another fluid dispensing pump 720 that may be used to pump fluid from a container 722 to the conduit 24 that supplies fluid to the nozzle 20 or 120 or 220 as described above. The fluid dispensing pump 720 can be mounted on the side of the toilet tank as in FIG. 1, or placed on the top of the toilet tank, or placed on the floor. The fluid dispensing pump 720 may be attached to the container 722 by way of a threaded closure 724 in a conventional manner.

The fluid dispensing pump 720 includes a piston 725 having an upper end grip 726 that defines an actuator. The piston 725 also has a piston head 728. The piston 725 translates in a collar 734 that is mounted on a hollow cylinder 736 that defines a pump chamber and that is integral with a base 738 that is secured to the closure 724. The piston head 728 seals against an inner surface 742 of the cylinder 736. A helical compression spring 744 is arranged between a lower surface of the end grip 726 of the piston 725 and an upper surface of the collar 734. The cylinder 736 is oriented parallel with a vertical (longitudinal) axis of the container 722.

The base 738 has central manifold 746 in fluid communication with an inlet port 752 that receives a dip tube 754 for sucking fluid from the container 722. A ball valve 755 seats on the inlet port 752 for preventing fluid from reentering the container 722 on a downstroke of the piston 725. A fluid passageway 756 places the cylinder 736 and the manifold 746 in fluid communication. The base 738 also has a discharge conduit 758 in fluid communication with the central manifold 746. The conduit 24 may be placed in fluid communication with the discharge conduit 758 by way of a coupling 762. A ball valve 764 is biased against a valve seat 765 of the discharge conduit 758 by way of compression spring 766. The ball valve 764 allows fluid flow out of the discharge conduit 758 on a piston downstroke but prevents fluid from reentering the central manifold 746 on an upstroke of the piston 725.

The piston 725 is shown in FIG. 18 in its upper position. When the piston 725 is pressed downward in direction D by a hand (or foot) and released, fluid from the container 722 is suctioned into the cylinder 736 on the upstroke of the piston 725 (the upstroke being effectuated by the upward biasing force of the spring 744). Thus, the pump 720 is primed. A subsequent downstroke of the piston 725 forces fluid past the ball valve 764 and out the discharge conduit 24. Fluid entering the conduit 24 is sprayed by nozzle 20 or 120 or 220 onto the inside surface 26 of the toilet bowl 12 as described above.

The amount of fluid delivered by a downstroke of the piston 725 can be varied by adjusting distance between the end grip 726 of the piston 725 and the collar 734. The means for varying the downstroke of the piston 725 comprises a shaft 772, a collar 774 and a set screw 776. The shaft 772 is attached to an underside of the end grip 726 of the piston 725, and the shaft 772 translates an opening in the collar 774. The set screw 776 is inserted in a threaded side opening in the collar 774 and can immobilize the shaft 772 in the collar 774 by way of contact of the set screw 776 with the shaft 772. By moving the shaft 772 downward in the collar 774 and immobilizing the shaft 772 with the set screw 776, the distance between the end grip 726 of the piston 725 and the collar 734 is decreased and therefore, lower volumes of fluid are sucked into the cylinder 736 on the upstroke of the piston 725. In one example embodiment, the fluid dispensing pump 720 can deliver up to 10 milliliters of fluid on a downstroke of the piston 725, with a delivery of 5 to 10 milliliters being preferred, and a delivery of 7 to 8 milliliters being most preferred.

Thus, the present invention provides a rotary sprayer for a fluid delivery device. The rotary sprayer can be used in an automatic or manual toilet bowl cleaning device where the inner surface of the toilet bowl is sprayed with a cleaner around the entire circumference of the toilet bowl. As a result, full coverage of the fluid around the inner surface of the toilet bowl is possible.

Although the present invention has been described in detail with reference to certain embodiments, one skilled in the art will appreciate that the present invention can be practiced by other than the described embodiments, which have been presented for purposes of illustration and not of limitation. Therefore, the scope of the invention should not be limited to the description of the embodiments contained herein.

### INDUSTRIAL APPLICABILITY

The present invention provides a rotary sprayer for a fluid delivery device such that fluid may be dispensed onto the inner wall surface of an enclosure.

What is claimed is:

1. A rotary sprayer for a fluid delivery device, the rotary sprayer comprising:
a clip including a fluid inlet having a discharge orifice and including an arm having a distal end section axially spaced from the fluid inlet; and
a nozzle including a deflection plate, a pair of spaced apart walls extending away from a first surface of the deflection plate and defining a channel on the first surface of the deflection plate, a spindle extending away from an opposite second surface of the deflection plate, and a passageway in fluid communication with the channel and an end space between the pair of walls, the first surface of the deflection plate including a perimeter section that ramps away from the second surface of the deflection plate,
wherein the fluid inlet is positioned in the end space and the spindle is mounted to the distal end section of the arm such that fluid exiting the discharge orifice flows through the passageway and through the channel and contacts an inner surface of at least one of the pair of walls to rotate the nozzle.

2. The rotary sprayer of claim 1 wherein:
the end space is a depression formed in an end of one or both of the pair of walls.

3. The rotary sprayer of claim 1 wherein:
the distal end section of the arm includes a recess opening toward the fluid inlet, and
the spindle is positioned in the recess.

4. The rotary sprayer of claim 1 wherein:
an outer end section of an inner surface of one of the pair of walls is curved toward the other of the pair of walls.

5. The rotary sprayer of claim 1 wherein:
the pair of walls are spaced inward from a perimeter of the deflection plate.

6. The rotary sprayer of claim 1 wherein:
the pair of walls are joined by an end wall such that the channel opens toward one side of the deflection plate.

7. The rotary sprayer of claim 1 wherein:
the channel opens toward opposite sides of the deflection plate.

8. The rotary sprayer of claim 1 wherein:
a deflection peak extending away from the first surface of the deflection plate between the pair of walls divides the channel into sections that open toward opposite sides of the deflection plate.

9. The rotary sprayer of claim 1 wherein:
the deflection plate is circular.

10. The rotary sprayer of claim 1 wherein:
the clip includes a hook for mounting the clip on an enclosure.

11. A rotary sprayer for a fluid delivery device, the rotary sprayer comprising:
a clip including a fluid inlet having a discharge orifice and including an arm having a distal end section axially spaced from the fluid inlet; and
a nozzle including a deflection plate having a perimeter, a pair of spaced apart walls extending away from a first surface of the deflection plate, a deflection peak extending away from the first surface of the deflection plate between the pair of walls, the deflection peak and the pair of walls defining oppositely directed channels on the first surface of the deflection plate, a spindle extending away from an opposite second surface of the deflection plate, and a passageway in fluid communication with the channels and an end space between the pair of walls, the pair of walls being spaced inward from the perimeter of the deflection plate,
wherein the fluid inlet is positioned in the end space and the spindle is mounted to the distal end section of the arm such that fluid exiting the discharge orifice flows through the passageway and through the channels and contacts an inner surface of at least one of the pair of walls to rotate the nozzle.

12. The rotary sprayer of claim 11 wherein:
the end space is a depression formed in an end of one or both of the pair of walls.

13. The rotary sprayer of claim 11 wherein:
the distal end section of the arm includes a recess opening toward the fluid inlet, and
the spindle is positioned in the recess.

14. The rotary sprayer of claim 11 wherein:
an outer end section of an inner surface of a first wall of the pair of walls is curved toward a second wall of the pair of walls, and
an outer end section of an inner surface of the second wall of the pair of walls is curved toward the first wall of the pair of walls.

15. The rotary sprayer of claim 11 wherein:
the deflection plate is circular.

16. The rotary sprayer of claim 11 wherein:
the clip includes a hook for mounting the clip on an enclosure.

17. The rotary sprayer of claim 11 wherein:
the pair of walls are generally inverted T-shaped.

18. A method for spraying an inner surface of an enclosure with a fluid, the method comprising:
(a) mounting a rotary sprayer adjacent a wall of the enclosure, the rotary sprayer comprising
(i) a clip including a fluid inlet having a discharge orifice and including an arm having a distal end section axially spaced from the fluid inlet; and
(ii) a nozzle including a deflection plate, a pair of spaced apart walls extending away from a first surface of the deflection plate and defining a channel on the first surface of the deflection plate, a spindle extending away from an opposite second surface of the deflection plate, and a passageway in fluid communication with the channel and an end space between the walls, wherein the fluid inlet is positioned in the end space and the spindle is mounted to the distal end section of the arm; and
(b) moving the fluid into the fluid inlet such that fluid exiting the discharge orifice of the fluid inlet flows through the passageway and through the channel and contacts an inner surface of at least one of the pair of walls to rotate the nozzle and spray the inner surface of the enclosure with the fluid.

19. The method of claim 18 wherein:
the enclosure extends upward from a support surface and fluid flowing through the passageway flows onto the first surface of the deflection plate in a direction toward the support surface.

20. The method of claim 18 wherein:
the enclosure is a toilet bowl.

21. The method of claim 20 wherein:
the inner surface of the toilet bowl is sprayed around the entire circumference of the toilet bowl.

22. The method of claim 18 wherein:
the enclosure is one of a tub or a shower.

23. The method of claim 18 wherein:
the first surface of the deflection plate includes a perimeter section that ramps away from the second surface of the deflection plate.

24. The method of claim 18 wherein:
step (b) comprises moving the fluid into the fluid inlet at a pressure of about 20 to about 103 kilopascals.

25. The method of claim 18 wherein:
step (b) comprises moving the fluid into the fluid inlet at a pressure of about 20 to about 207 kilopascals.

26. The method of claim 18 wherein:
step (b) comprises moving the fluid into the fluid inlet at a flow rate below 38 liters per hour.

27. The method of claim 18 wherein:
step (b) comprises pumping the fluid into the fluid inlet.
